(19) United States
(12) Patent Application Publication
(10) Pub. No.: US 2023/0300766 A1
(43) Pub. Date: Sep. 21, 2023

(54) METHOD OF PROPAGATION DELAY COMPENSATION AND RELATED DEVICES

(71) Applicant: PURPLEVINE INNOVATION COMPANY LIMITED, Hong Kong (CN)

(72) Inventor: Yi-Ting LIN, Hong Kong (CN)

(21) Appl. No.: 17/642,961

(22) PCT Filed: Oct. 14, 2021
(86) PCT No.: PCT/CN2021/123938

§ 371 Date: Mar. 15, 2022

Related U.S. Application Data
(60) Provisional application No. 63/091,360, filed on Oct. 14, 2020.

(51) Int. Cl. H04W 56/00; H04W 74/08

(52) U.S. Cl. CPC H04W 56/0045; H04W 74/0833

(57) ABSTRACT

A method of propagation delay compensation (PDC), a user equipment (UE) and a base station (BS) are provided. The method includes being indicated by a PDC indication; determining whether to perform PDC based on the PDC indication; being indicated by timing advance; and performing the PDC based on the timing advance in response to determining to perform the PDC. With this method, PDC control or management flexibility is improved.

### CROSS-REFERENCE TO RELATED APPLICATION

This application claims the benefits of International Application No. PCT/CN2021/123938 filed on Oct. 14, 2021, which claims the priority to a U.S. Provisional Application No. 63/091,360 filed on Oct. 14, 2020. The entire disclosures of above applications are incorporated herein by reference.

### BACKGROUND OF THE DISCLOSURE

### 1. Field of the Disclosure

The present application relates to wireless communication, and more particularly, to a method of propagation delay compensation (PDC), and related devices such as a user equipment (UE) and a base station (BS).

### 2. Description of the Related Art

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, a user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

The URLLC is a communication service for successfully delivering packets with stringent requirements, particularly in terms of availability, latency, and reliability. The URLLC will enable supporting the emerging applications and services. Example services include wireless control and automation in industrial factory environments, inter-vehicular communications for improved safety and efficiency, and the tactile internet. It is of importance for 5G especially considering the effective support of verticals which brings new business to the whole telecommunication industry.

Time Sensitive Network (TSN) is a set of standards (IEEE 802.1Q TSN Standard) developed by IEEE to define a mechanism for the time-sensitive transmission of data and accurate timing reference over a wired Ethernet network. The accurate reference timing emanates from a central clock source known as Grand Master, and its distribution through a series of hops between nodes is based on the Precision Time Protocol.

One of the important requirements of NR system supports for some form of interworking with the TSN. As illustrated in FIG. 1, the 5G system (5GS) acts as a “Black Box” in the TSN networking. TSN provides the accurate reference timing to the 5GS. The 5GS is able to distribute the TSN derived accurate timing to all the UEs in the system. In addition, the 5GS is capable of compensating for any time drifts resulting from delays in the air interface.

Propagation Delay Compensation (PDC) has been discussed extensively in 3GPP meetings as a key issue of TSN service. Based on the studies in 3GPP technical specification Release 16, the work of propagation delay compensation in Release 17 includes the following: (1) Downlink (DL) propagation delay compensation should be needed for distance >200 m or UE-to-UE communication. (2) Propagation delay compensation should be done by UE implementation (because the indicated time is referenced at the network). (3) Timing advanced should be the method for propagation delay compensation. But whether and how to perform propagation delay compensation supporting time sensitive services for a UE in Radio Resource Control (RRC) connected/idle/inactive state is still a problem to be resolved.

### SUMMARY

An objective of the present application is to provide a method of propagation delay compensation (PDC), a user equipment (UE) and a base station (BS) for solving the problems in the existing arts.

In a first aspect, an embodiment of the present application provides a method of propagation delay compensation (PDC), performed by a UE, the method including: (a) being indicated by a PDC indication; (b) determining whether to perform PDC based on the PDC indication; (c) being indicated by timing advance; and (d) performing the PDC based on the timing advance in response to determining to perform the PDC in step (b).

In a second aspect, an embodiment of the present application provides a method of propagation delay compensation (PDC), performed by a BS, the method including: (a) indicating to a user equipment (UE) by a PDC indication; (b) expecting the UE to determine whether to perform PDC based on the PDC indication; (c) indicating to the UE by timing advance; and (d) expecting the UE to perform the PDC based on the timing advance in response to the UE determining to perform the PDC in step (b).

In a third aspect, an embodiment of the present application provides a UE, communicating with a BS in a network, the UE including a processor, configured to call and run program instructions stored in a memory, to execute the method of the first aspect.

In a fourth aspect, an embodiment of the present application provides a BS, communicating with a UE in a network, the BS including a processor, configured to call and run program instructions stored in a memory, to execute the method of the second aspect.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### BRIEF DESCRIPTION OF THE DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating time synchronization in a 5G system.

FIG. 2 is a block diagram illustrating one or more UEs, a base station and a network entity device in a communication network system according to an embodiment of the present application.

FIG. 3 is a flowchart of a method of propagation delay compensation according to an embodiment of the present application.

FIG. 4 is a flowchart of a method of propagation delay compensation during random access procedure for UE in RRC inactive/idle.

FIG. 5 is a flowchart of a method of propagation delay compensation during RRC connected.

FIG. 6 is a flowchart of a method of propagation delay compensation by UE request.

FIG. 7 is a schematic diagram illustrating a MAC subheader.

FIG. 8 is a schematic diagram illustrating a MAC subheader.

FIG. 9 is a schematic diagram illustrating Timing Advance Command MAC CE.

FIG. 10 is a schematic diagram illustrating an example of Enhanced Timing Advance Command MAC CE.

FIG. 11 is a schematic diagram illustrating another example of Enhanced Timing Advance Command MAC CE.

FIG. 12 is a schematic diagram illustrating an example of a DL MAC PDU with enhanced timing advance MAC CE.

FIG. 13 is a schematic diagram illustrating an example of Enhanced Timing Advance Command MAC CE.

FIG. 14 is a schematic diagram illustrating another example of Enhanced Timing Advance Command MAC CE.

FIG. 15 is a schematic diagram illustrating an example of a DL MAC PDU with timing advance MAC CE plus enhanced timing advance MAC CE.

FIG. 16 is a schematic diagram illustrating E/T/R/R/BI MAC subheader.

FIG. 17 is a schematic diagram illustrating E/T/RAPID MAC subheader.

FIG. 18 is a schematic diagram illustrating an example of MAC PDU consisting of MAC RARs with enhanced timing advance MAC CE.

FIG. 19 is a schematic diagram illustrating breakdown of the 5GS end-to-end path.

FIG. 20 is a schematic diagram illustrating evaluation on the time synchronization accuracy over Uu interface.

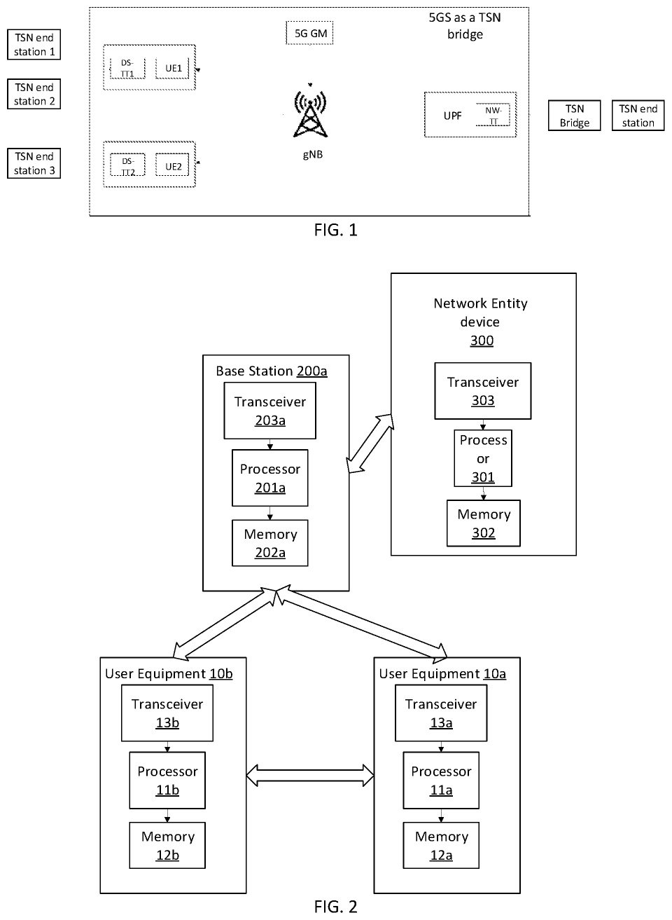

### DETAILED DESCRIPTION OF THE EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, the term “/” should be interpreted to indicate “and/or.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Regarding propagation delay compensation (PDC) between a user equipment (UE) and a base station (BS) (e.g., gNB) in a 5G system, there are two questions that should be considered first. One is when does the UE perform propagation delay compensation, and the other one is how does the BS control the PDC for UEs.

For the question, when does the UE perform propagation delay compensation, there may have two proposals as below. (1) A UE may always perform PDC, such that each UE can reduce the impact from propagation delay. However, this will increase the complexity for the UEs that does not need the URLLC services and for the UEs that is close to the gNB (e.g., distance >200 m). (2) The UEs whose TA is more than or equal to a threshold (e.g., 3) may need to perform PDC. Because T_{A} is indicated by the gNB, the gNB will know which UE performs PDC if the gNB and the UE follow the same rule (i.e., T_{A} is more than or equal to 3) at the same time.

When calculating the timing advance (i.e., T_{A}), a function N_{TA}=T_{A}*16*64/2^{u} is used in recent 3 GPP technical specification Release 16 or 17. For 15 kHz subcarrier spacing, u=0. Therefore N_{TA}=T_{A}*16*64. Timing advanced=(N_{TA}+N_{TA,offset})*T_{c}=T_{A}*16*64*T_{c} where T_{c}=0.509 ns and N_{TA,offset}=0 for FR1 FDD. Then, (3*10⁸(m/s)*T_{A}*16*64*0.509*10⁻⁹(s))/2>200 m, it can be known that 78.1824*T_{A}>200 m. Therefore, T_{A}>2.56. T_{A} granularity error is large, and it finally determines that T_{A}>=3.

For the question, how does the gNB control the PDC for UEs, there may have two proposals as below. Based on the calculated TA value, the gNB can indicate the UE to do or not to do PDC. (1) By default, a UE may always perform PDC regardless of the TA value. In this case, the gNB can indicate the UE not to do PDC when the estimated TA value is smaller than or equal to 2. (2) By default, a UE may always not perform PDC. In this case, the gNB can indicate the UE to do PDC when the estimated TA value is larger than or equal to 3. This case is a better one because it is wasteful for a UE always doing PDC though the previous case is also considered possible.

FIG. 2 illustrates that, in some embodiments, one or more user equipments (UEs) 10a, 10b, a base station (e.g., gNB or eNB) 200a and a network entity device 300 for wireless communication in a communication network system according to an embodiment of the present application are provided. With reference to FIG. 2, a UE 10a, a UE 10b, a base station 200a, and a network entity device 300 executes embodiments of the method according to the present application. Connections between devices and device components are shown as lines and arrows in the FIG. 2. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocols may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives radio signals. The base station 200a may be an eNB, a gNB, or one of other radio nodes.

Each of the processor 11a, 11b, 201a, and 301 may include a general-purpose central processing unit (CPU), an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium, other storage devices, and/or any combination of the memory and storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art. The network entity device 300 may be a node in a central network (CN). CN may include LTE CN or 5G core (5GC) which may include user plane function (UPF), session management function (SMF), access and mobility management function (AMF), unified data management (UDM), policy control function (PCF), control plane (CP)/user plane (UP) separation (CUPS), authentication server function (AUSF), network slice selection function (NSSF), the network exposure function (NEF), and other network entities.

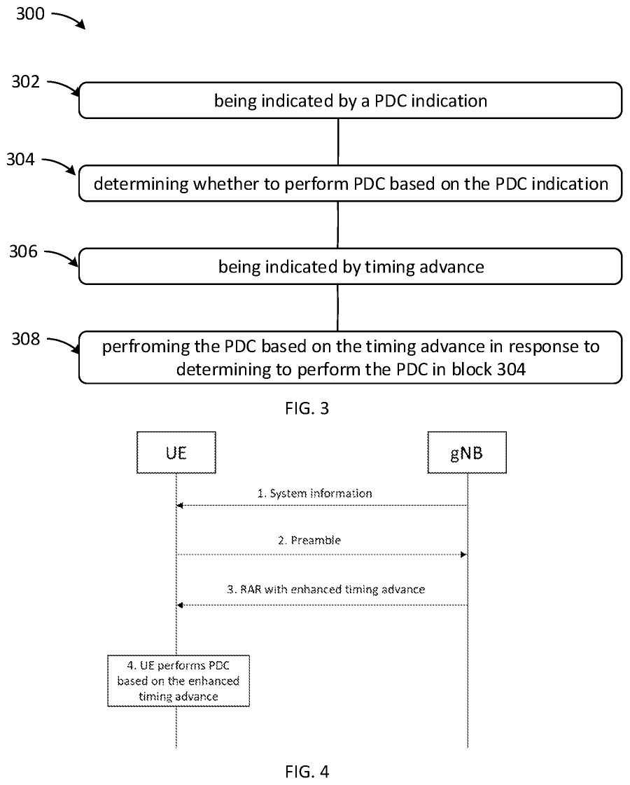

FIG. 3 is a flowchart of a method 300 of propagation delay compensation according to an embodiment of the present application. In some embodiments, referring to FIG. 3 in conjunction with FIG. 2, the method 300 may include the followings. In block 302 of the method 300, the UE is indicated (the BS indicates to the UE) by a PDC indication. In block 304, the UE determines whether to perform PDC based on the PDC indication. In block 306, the UE is indicated (the BS indicates to the UE) by timing advance. In block 308, the UE performs the PDC based on the timing advance in response to determining to perform the PDC in block 304. It is noted that the order of blocks 302, 304, 306 and 308 is not limited. Particularly, the block 302 may be performed before or after the block 306. The method 300 can solve issues in the existing arts, improve PDC control or management flexibility, enhance the reliability of the network and/or provide good communication performance.

The followings provide three exemplary procedures of performing propagation delay compensation by a UE, that is, (a) UE is in Radio Resource Control (RRC) inactive/idle; (b) UE is in RRC connected (gNB initiated); and (c) UE is in RRC connected (UE initiated).

(a) UE is in Radio Resource Control (RRC) Inactive/Idle

Please refer to FIG. 4, which is a flowchart of a method of propagation delay compensation during random access procedure for UE in RRC inactive/idle.

Step 1: A gNB broadcast system information (SI) (e.g., system information block (SIB9)) to a UE. The system information carries reference time information (e.g., ReferenceTimeInfo-r16) which provides the reference time for UE calibration. After receiving the ReferenceTimeInfo-16, the UE will adjust its timing at the subframe indicated by the ReferenceTimeInfo-16. In this step, the UE will not perform PDC because the gNB did not receive any uplink (UL) signal from the UE to estimate timing advance for the UE. However, the gNB may indicate to all UEs whether to perform PDC through a PDC common indication (e.g., PropagationDelayCompensationCommon) information element (IE) of the reference time information. For example, if the scenario is indoor small cell (e.g., the number of hops between the Time Sensitive Network (TSN) device and the 5G GM is only one), the gNB may indicate all UEs not to perform PDC by configuring PropagationDelayCompensationCommon as false. If the scenario is outdoor large cell (e.g., there are multiple gNBs serving all UEs), the gNB may indicate all UEs to perform PDC by configuring PropagationDelayCompensationCommon as true. Other influencing factors include different deployment (single-gNB, multi-gNB, multi-distributed unit (DU)/transmission/reception point (TRP)) and different cell sizes. The gNB may also provide with a PDC threshold for all the UEs to perform PDC. When the received timing advance, T_{A}, in the following step is greater than or equal to the PDC threshold (e.g., PropagationDelayCompensationThreshold of the reference time information), the UEs shall perform PDC. The PropagationDelayCompensationCommon and the PropagationDelayCompensationThreshold are used for configuring all UEs in RRC inactive/idle state whether to perform PDC.

Step 2: When the UE wants to establish connection with the gNB, the UE transmits a preamble to the gNB. The establishment cause may be mobile-originated data transmission or paging by the gNB because of mobile-terminated data transmission.

Step 3: Based on the received preamble, the gNB estimates the timing advance (or enhanced timing advance, which will be described in details below) for the UE. Then the gNB responses with a random access response (RAR) including the timing advance (or enhanced timing advance) and propagation delay compensation indication. The gNB configures the propagation delay compensation indication=1 when the estimated timing advance (or enhanced timing advance) is larger than or equal to a specific value. The specific value may be between 2 and 3. Otherwise, the gNB configures the propagation delay compensation indication=0. The propagation delay compensation indication is used for the UE to determine whether to perform PDC.

Step 4: The UE performs PDC based on the propagation delay compensation indication, and the timing advance (or enhanced timing advance). For example, when the propagation delay compensation indication=1, the UE performs PDC based on the timing advance (or enhanced timing advance). When the propagation delay compensation indication=0, the UE will not perform PDC.

It is noted that the propagation delay compensation indication in Medium Access Control (MAC) Control Element (CE) in RAR message may be an alternative to the PropagationDelayCompensationCommon and the PropagationDelayCompensationThreshold in the RRC messages. One of the methods of PDC indication could be used for UEs to determine when and how to perform PDC. In an embodiment, the UEs may determine whether to perform the PDC based on the latest received PDC indication.

(b) UE is in RRC Connected (gNB Initiated)

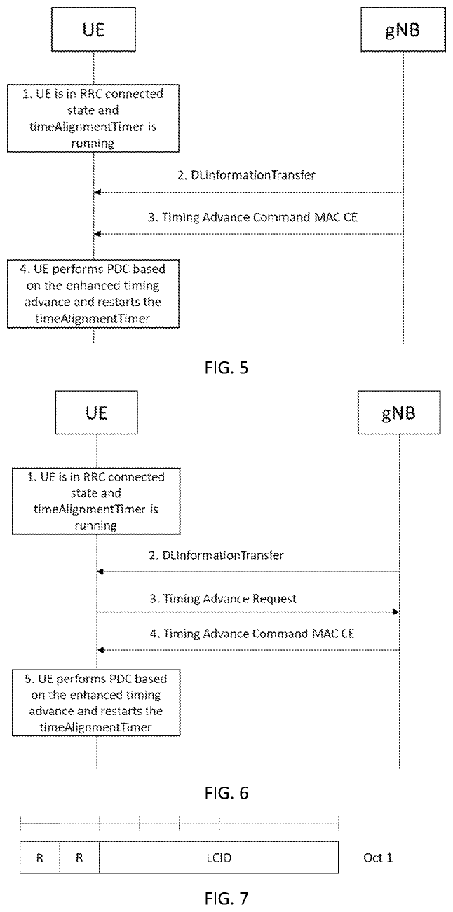

Please refer to FIG. 5, which is a flowchart of a method of propagation delay compensation during RRC connected.

Step 1: After receiving timing advance (or enhanced timing advance) from RAR, the UE will start timeAlignmentTimer. Then after finishing random access procedure, the UE enters RRC connected state. When the timeAlignmentTimer is running, the UE maintains time synchronization with the gNB.

Step 2: The gNB may update the reference time information (e.g., ReferenceTimeInfo-r16) through a downlink (DL) information transfer message (e.g., DLinformationTransfer message). The DLinformationTransfer message may include the PropagationDelayCompensationDedicated-r16 and/or the PropagationDelayCompensationThreshold which are used for the UE to determine whether to perform PDC. The PropagationDelayCompensationDedicated-r16 is similar to the PropagationDelayCompensationCommon except that it is UE dedicated and the function of PropagationDelayCompensationThreshold is similar to or the same as that used for UE in RRC inactive/idle as described above, which are not repeated herein.

Step 3: The gNB will maintain a timeAlignmentTimer for each UE. Before the timeAlignmentTimer expires, the gNB transmits Timing Advance Command MAC CE to the UE to maintain synchronization with the UE. The Timing Advance Command MAC CE may include at least one of timing advance (or enhanced timing advance) and propagation delay compensation indication. It is noted that the gNB configures the propagation delay compensation indication=1 when the estimated timing advance (or enhanced timing advance) is larger than or equal to a specific value. The specific value may be between 2 and 3. Otherwise, the gNB configures the propagation delay compensation indication=0.

It is noted that only one of RRC-based PropagationDelayCompensationDedicated-r16 and MAC-based propagation delay compensation indication may be used for informing the UE whether to perform PDC.

Step 4: After receiving the DLinformationTransfer/Timing Advance Command MAC CE, the UE performs PDC based on the PropagationDelayCompensationDedicated-r16/propagation delay compensation indication and the timing advance (or enhanced timing advance), and then restarts timinAlignmentTimer.

(c) UE is in RRC Connected (UE Initiated)

Please refer to FIG. 6, which is a flowchart of a method of propagation delay compensation by UE request.

Step 1: After receiving timing advance (or enhanced timing advance) from RAR, the UE will start timeAlignmentTimer. Then after finishing random access procedure, the UE enters RRC connected state. When the timeAlignmentTimer is running, the UE maintains time synchronization with the gNB.

Step 2: The gNB may update the reference time information (e.g., ReferenceTimeInfo-r16) through a downlink (DL) information transfer message (e.g., DLinformationTransfer message). The DLinformationTransfer message may include the PropagationDelayCompensationDedicated-r16 and/or the PropagationDelayCompensationThreshold which are used for the UE to determine whether to perform PDC. The PropagationDelayCompensationDedicated-r16 is similar to the PropagationDelayCompensationCommon except that it is UE dedicated and the function of PropagationDelayCompensationThreshold is similar to or the same as that used for UE in RRC inactive/idle as described above, which are not repeated herein.

Step 3: When the UE moves quickly (e.g., more than 30 m/s), the propagation delay changes during 1 second is about 100 ns. Therefore, the UE may request to update its timing advance before timAlignmentTimer expires. The timing advance request message may be a MAC CE or an RRC message.

Step 4: After receiving timing advance request message, the gNB transmits Timing Advance Command MAC CE to the UE to update timing advance for the UE. The Timing Advance Command MAC CE may include at least one of timing advance (or enhanced timing advance) and propagation delay compensation indication. It is noted that only one of RRC-based PropagationDelayCompensationDedicated-r16 and MAC-based propagation delay compensation indication may be used for informing the UE whether to perform PDC.

Step 5: After receiving the Timing Advance Command MAC CE, the UE performs PDC based on the PropagationDelayCompensationDedicated-r16/propagation delay compensation indication and the timing advance (or enhanced timing advance), and then restarts timinAlignmentTimer.

RRC control messages modifications:

New reference time information (e.g., ReferenceTimelnfo) information element carried in (a) broadcast message (e.g., system information block) and (b) unicast message (e.g., DL information transfer message) is proposed in the present application.

(a) Broadcast message:

SIB9 contains information related to GPS time and Coordinated Universal Time (UTC). The UE may use the parameters provided in this system information block to obtain the UTC, the GPS and the local time. NOTE: The UE may use the time information for numerous purposes, possibly involving upper layers e.g., to assist GPS initialisation, to synchronise the UE's clock.

TABLE 1
SIB9 information element

| | | |
|---|---|---|
| -- ASN1START | | |
| -- TAG-SIB9-START | | |
| SIB9 ::= | SEQUENCE { | |
| timeInfo | SEQUENCE { | |
| timeInfoUTC | INTEGER (0..549755813887), | |
| dayLightSavingTime | BIT STRING (SIZE (2)) | OPTIONAL, -- Need R |
| leapSeconds | INTEGER (-127..128) | OPTIONAL, -- Need R |
| localTimeOffset | INTEGER (-63..64) | OPTIONAL -- Need R |
| } | | OPTIONAL, -- Need R |
| lateNonCriticalExtension | OCTET STRING | OPTIONAL, |
| ..., | | |
| [[ | | |
| referenceTimeInfo-r16 | ReferenceTimeInfo-r16 | OPTIONAL -- Need R |
| ]] | | |
| } | | |
| -- TAG-SIB9-STOP | | |
| -- ASN1STOP | | |

—ReferenceTimeInfo

The IE ReferenceTimeInfo contains timing information for 5G internal system clock used for, e.g., time stamping.

TABLE 2
-- ASN1START
-- TAG-REFERENCETIMEINFO-START
ReferenceTimeInfo-r16 ::= SEQUENCE {

| time-r16 | ReferenceTime-r16, | |
|---|---|---|
| uncertainty-r16 | INTEGER (0..32767) | OPTIONAL, -- Need S |
| timeInfoType-r16 | ENUMERATED {localClock} | OPTIONAL, -- Need S |
| referenceSFN-r16 | INTEGER (0..1023) | OPTIONAL, -- Cond RefTime |
| PropagationDelayCompensationCommon-r16 | BOOLEAN | OPTIONAL, -- Need M |
| PropagationDelayCompensationDedicated-r16 | BOOLEAN | OPTIONAL -- Need M |
| PropagationDelayCompensationThreshold | ENUMERATED {zero, TAtwoandoneeigth, TAtwoandtwoeigths, | |
| | | TAtwoandthreeeigths, TAtwoandfoureigths, |
| | | TAtwoandfiveeigths, |
| | | TAtwoandsixeigths, TAtwoandseveneigths, |
| | | TAthree, infinity} |
| | | OPTIONAL -- Need M |
| } | | |

| | |
|---|---|
| ReferenceTime-r16 ::= | SEQUENCE { |
| refDays-r16 | INTEGER (0..72999), |
| refSeconds-r16 | INTEGER (0..86399), |
| refMilliSeconds-r16 | INTEGER (0..999), |
| refTenNanoSeconds-r16 | INTEGER (0..99999) |

}
-- TAG-REFERENCETIMEINFO-STOP
-- ASN1STOP

It is noted that PropagationDelayCompensationCommon is configured for all UEs in a cell. When PropagationDelayCompensationCommon is configured as true, all UEs in a cell shall perform propagation delay compensation. When PropagationDelayCompensationCommon is absent, all UEs shall act as previous PropagationDelayCompensationCommon indicated. PropagationDelayCompensationThreshold provides a value of threshold for all UEs to perform PDC. When the received TA is greater than or equal to the PropagationDelayCompensationThreshold, the UEs shall perform PDC.

(b) Unicast message:

The DLInformationTransfer message is used for the downlink transfer of NAS dedicated information and timing information for the 5G internal system clock. Signalling radio bearer: SRB2 or SRB1 (only if SRB2 not established yet. If SRB2 is suspended, the network does not send this message until SRB2 is resumed.) RLC-SAP: AM. Logical channel: DCCH. Direction: Network to UE

TABLE 3
-- ASN1START
-- TAG-DLINFORMATIONTRANSFER-START

| | |
|---|---|
| DLInformationTransfer ::= | SEQUENCE { |
| rrc-TransactionIdentifier | RRC-TransactionIdentifier, |
| criticalExtensions | CHOICE { |
| dlInformationTransfer | DLInformationTransfer-IEs, |
| criticalExtensionsFuture | SEQUENCE {} |

}
}

| DLInformationTransfer-IEs ::= | SEQUENCE { | |
|---|---|---|
| dedicatedNAS-Message | DedicatedNAS-Message | OPTIONAL, -- Need N |
| lateNonCriticalExtension | OCTET STRING | OPTIONAL, |
| nonCriticalExtension | DLInformationTransfer-v1610-IEs | OPTIONAL |

}
DLInformationTransfer-v1610-IEs ::= SEQUENCE {

| | | |
|---|---|---|
| referenceTimeInfo-r16 | ReferenceTimeInfo-r16 | OPTIONAL, --Need R |
| nonCriticalExtension | SEQUENCE { } | OPTIONAL |

}
-- TAG-DLINFORMATIONTRANSFER-STOP
-- ASN1STOP

ReferenceTimeInfo

The IE ReferenceTimelnfo contains timing information for 5G internal system clock used for, e.g., time stamping.

ReferenceTimeInfo information element

TABLE 4
-- ASN1START
-- TAG-REFERENCETIMEINFO-START
ReferenceTimeInfo-r16 ::= SEQUENCE {

| time-r16 | ReferenceTime-r16, | |
|---|---|---|
| uncertainty-r16 | INTEGER (0..32767) | OPTIONAL, -- Need S |
| timeInfoType-r16 | ENUMERATED {localClock} | OPTIONAL, -- Need S |
| referenceSFN-r16 | INTEGER (0..1023) | OPTIONAL, -- Cond RefTime |
| PropagationDelayCompensationCommon-r16 | BOOLEAN | OPTIONAL, -- Need M |
| PropagationDelayCompensationDedicated-r16 | BOOLEAN | OPTIONAL -- Need M |

| | |
|---|---|
| PropagationDelayCompensationThreshold | ENUMERATED {zero, TAtwoandoneeigth, TAtwoandtwoeigths, |

TAtwoandthreeeigths, TAtwoandfoureigths,
TAtwoandfiveeigths,
TAtwoandsixeigths, TAtwoandseveneigths,
TAthree, infinity}
OPTIONAL -- Need M

| | |
|---|---|
| } | |
| ReferenceTime-r16 ::= | SEQUENCE { |
| refDays-r16 | INTEGER (0..72999), |
| refSeconds-r16 | INTEGER (0..86399), |
| refMilliSeconds-r16 | INTEGER (0..999), |
| refTenNanoSeconds-r16 | INTEGER (0..99999) |

}
-- TAG-REFERENCETIMEINFO-STOP
-- ASN1STOP

It is noted that PropagationDelayCompensationDedicated is configured for a specific UE in a cell. When PropagationDelayCompensationDedicated is configured as true, the UE in a cell shall perform propagation delay compensation. When PropagationDelayCompensationDedicated is absent, the UE shall perform as previous PropagationDelayCompensationDedicated.

PropagationDelayCompensationThreshold provides a value of threshold for the UE to perform PDC. When the received TA is greater than or equal to the PropagationDelayCompensationThreshold, the UE shall perform PDC.

Enhanced granularity of timing advance (T_{A}) value

T_{A} value is sent in T_{A} command and according to recent 3 GPP technical specification release (Release 16 or 17), granularity of T_{A} value is 16·64·T_{c}/2^{μ}. Table 5 summarizes the inaccuracy caused by T_{A} indication for different subcarrier space (SCS).

TABLE 5

| | Different SCS (kHz) | | | |
|---|---|---|---|---|
| | (unit: ns) | | | |
| | 15 kHz | 30 kHz | 60 kHz | 120 kHz |
| Granularity of | 520 | 260 | 130 | 65 |
| T_{A} indication | | | | |
| Timing error caused | 260 | 130 | 65 | 32 |
| by T_{A} indication | | | | |

It can be known from recent 3GPP technical specification release that N_{TA}=T_{A}*16*64/2^{u}, where T_{A}=0, 1, 2, . . . , 3846. For 15 kHz SCS, u=0. When T_{A}=1, distance from the gNB=(3*10⁸(m/s)*1*16*64*0.509*10⁹(s))/2=78.18 m.

Based on above result, only UEs with a distance greater than 78.18 meters can be distinguished. This is not precise enough and will have impact on certain UEs. For example, how to configure timing advance for a UE 70 meters away from the gNB? Although cyclic prefix (CP) can resolve the UL transmission error such that the gNB can receive the UL transmission successful, it is not helpful to provide high accuracy timing between the UE and the gNB. Therefore, the granularity of timing advance should be enhanced to reduce timing error caused by T_{A} indication.

Based on the analysis of time synchronization error for indoor (e.g., control-to-control communication) and outdoor (e.g., smart grid communication) as will be described in details below, the synchronization accuracy requirement would be met if the timing advance granularity can be reduced to one fourth or even one eighth of the original one.

It is therefore proposed a use of an enhanced timing advance in comparison to a legacy timing advance. The enhanced timing advance may have a non-enhanced part and an enhanced part that are used together to control the amount of timing adjustment. The enhanced part may have one or more bits used to control part of the amount of timing adjustment. In an embodiment, the enhanced part of the enhanced timing advance is a decimal part with a value decided by a fraction with a non-zero denominator represented by one or more binary digits.

Timing Advance (T_{A}) Command MAC CE Design

MAC subheader for the enhanced timing advance is illustrated in FIG. 7, where:
R: Reserved bit, set to 0.
LCID: The Logical Channel ID field identifies the logical channel instance of the corresponding MAC Service Data Unit (SDU) or the type of the corresponding MAC CE or padding as described in Table 6 below for the DL-SCH. For example, the LCID for enhanced timing advance is set to 46.

TABLE 6

| Codepoint/ | |
|---|---|
| Index | LCID values |
| 0 | CCCH |
| 1-32 | Identity of the logical channel |
| 33 | Extended logical channel ID field (two-octet eLCID field) |
| 34 | Extended logical channel ID field (one-octet eLCID field) |
| 35-45 | Reserved |
| 46 | Enhanced timing advance |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

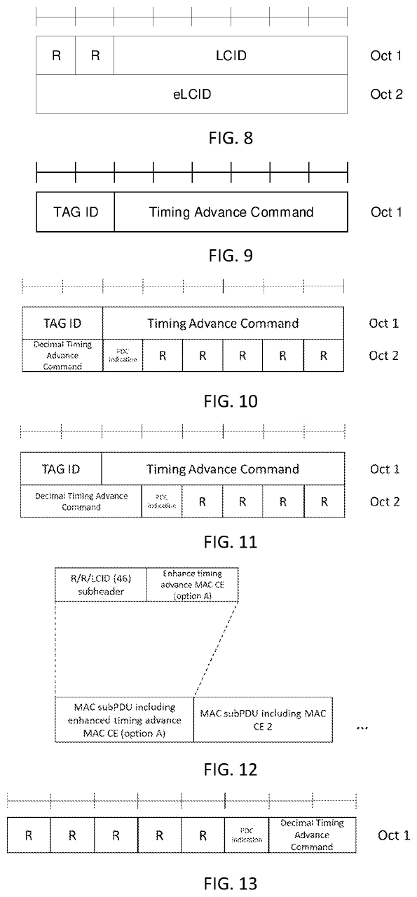

In another embodiment, MAC subheader for the enhanced timing advance is illustrated in FIG. 8, where:
R: Reserved bit, set to 0.
LCID: The Logical Channel ID field identifies the logical channel instance of the corresponding MAC Service Data Unit (SDU) or the type of the corresponding MAC CE or padding as described in Table 7 below for the DL-SCH. LCID is set to 33 for eLCID with one octet.

eLCID: The extended Logical Channel ID field identifies the logical channel instance of the corresponding MAC SDU or the type of the corresponding MAC CE as described in Table 7 below for the DL-SCH. For example, the eLCID for enhanced timing advance is set to Codepoint (244) with Index(308).

TABLE 7

| Codepoint | Index | LCID values |
|---|---|---|
| 0 to 243 | 64 to 307 | Reserved |
| 244 | 308 | Enhanced timing advance |
| 245 | 309 | Serving Cell Set based SRS Spatial |
| | | Relation Indication |
| 246 | 310 | PUSCH Pathloss Reference RS Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States |
| | | Activation/Deactivation for UE-specific |
| | | PDSCH |
| 251 | 315 | Duplication RLC Activation/Deactivation |
| 252 | 316 | Absolute Timing Advance Command |
| 253 | 317 | SP Positioning SRS |
| | | Activation/Deactivation |
| 254 | 318 | Provided Guard Symbols |
| 255 | 319 | Timing Delta |

Timing Advance Command MAC CE

The Timing Advance Command MAC CE is identified by MAC subheader with LCID as specified in Table 6 or Table 7 above. As illustrated in FIG. 9, it has a fixed size and consists of a single octet defined as follows:
TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply (as specified in recent 3 GPP technical specification. The length of the field is 6 bits.

Enhanced Timing Advance Command MAC CE (Option A)

The Enhanced Timing Advance Command MAC CE is identified by MAC PDU subheader with LCID as specified in Table 6 or Table 7 above. As illustrated in FIG. 10 and FIG. 11, it has a fixed size and consists of two octets defined as follows:
TAG Identity (TAG ID): This field indicates the TAG Identity of the addressed TAG. The TAG containing the SpCell has the TAG Identity 0. The length of the field is 2 bits;
Timing Advance Command: This field indicates the index value T_{A} (0, 1, 2 . . . 63) used to control the amount of timing adjustment that MAC entity has to apply. The length of the field is 6 bits.
Decimal Timing Advanced Command: This field indicates the decimal part of the corresponding TA. The range of decimal timing advance is 0/4to 3/4 in FIG. 10 (option 1) or 0/8- 7/8 in FIG. 11 (option 2). That is, the decimal part of the enhanced timing advance is determined by two binary digits and has a corresponding decimal value which is 0/4, ¼, 2/4 or ¾. Alternatively, the decimal part of the enhanced timing advance is determined by three binary digits and has a corresponding decimal value which is 0/8, ⅛, 2/8, ⅜, 4/8, ⅝, 6/8 or ⅞. It is noted that the decimal part may be represented by other number of bits, for example, 4 bits, 5 bits, and so on.
Propagation Delay Compensation (PDC) Indication: This field indicated whether to perform propagation delay compensation after receiving enhanced timing advance MAC CE. When PDC indication =1, the UE shall perform PDC. Otherwise, when PDC indication=0, the UE does not need to perform PDC.

An example of a DL MAC Protocol Data Unit (PDU) with enhanced timing advance MAC CE (Option A) is provided as illustrated in FIG. 12. The non-enhanced part and the enhanced part of the enhanced timing advance are carried in a same MAC sub Protocol Data Unit (subPDU). One MAC PDU subheader is used to indicate both the non-enhanced part and the enhanced part of the enhanced timing advance. It is noted that total length of the MAC PDU is 3 octets.

Enhanced Timing Advance Command MAC CE (Option B)

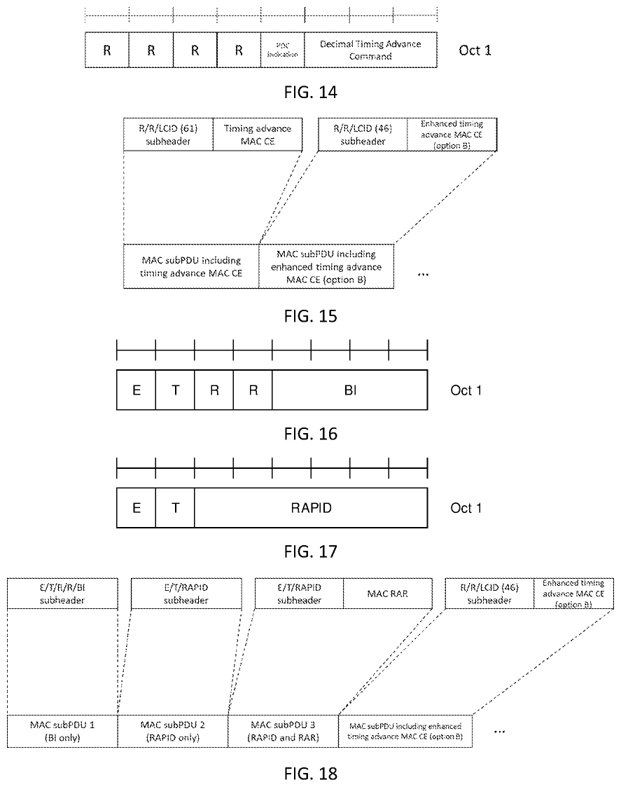

The Enhanced Timing Advance Command MAC CE is identified by MAC PDU subheader with LCID as specified in Table 6 or Table 7above. As illustrated in FIG. 13 and FIG. 14, it has a fixed size and consists of one octet defined as follows:
Decimal Timing Advanced Command: This field indicates the decimal part of the corresponding T_{A}. The range of decimal timing advance is 0/4- 3/4 in FIG. 13 (option 1) or 0/8- 7/8 in FIG. 14 (option 2). That is, the decimal part of the enhanced timing advance is determined by two binary digits and has a corresponding decimal value which is 0/4, ¼, 2/4 or ¾. Alternatively, the decimal part of the enhanced timing advance is determined by three binary digits and has a corresponding decimal value which is 0/8, ⅛, 2/8, ⅜, 4/8, ⅝, 6/8 or ⅞. It is noted that the decimal part may be represented by other number of bits, for example, 4 bits, 5 bits, and so on.
Propagation Delay Compensation (PDC) Indication: This field indicated whether to perform propagation delay compensation after receiving enhanced timing advance MAC CE. When PDC indication =1, the UE shall perform PDC. Otherwise, when PDC indication=0, the UE does not need to perform PDC.

An example of a DL MAC PDU with enhanced timing advance MAC CE (Option B) is provided as illustrated in FIG. 15. The non-enhanced part and the enhanced part of the enhanced timing advance are carried in two different MAC sub Protocol Data Units (subPDUs). One MAC PDU subheader is used to indicate the non-enhanced part and another one MAC PDU subheader is used to indicate the enhanced part of the enhanced timing advance. It is noted that total length of the MAC PDU is 4 octets.

MAC PDU (Random Access Response)

A MAC PDU consists of one or more MAC subPDUs and optionally padding. Each MAC subPDU consists one of the following:
a MAC subheader with Backoff Indicator only;
a MAC subheader with RAPID only (i.e., acknowledgment for SI request);
a MAC subheader with RAPID and MAC RAR; and
a MAC subheader with LCID and enhanced timing advance MAC CE (option B).

A MAC subheader with Backoff Indicator consists of five header fields E/T/R/R/BI as described in FIG. 16. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).

A MAC subheader with RAPID consists of three header fields E/T/RAPID as described in FIG. 17.

Padding is placed at the end of the MAC PDU if present. Presence and length of padding is implicit based on transmission block (TB) size, size of MAC subPDU(s). nd of the MAC PDU if present. Presence and length of padding is implicit based on TB size, size of MAC subPDU(s).

Since only one reserved bit is left in MAC RAR, it may not have enough space for carrying the enhanced timing advance as defined in option A above. Therefore, option B may be used, the non-enhanced part of the enhanced timing advance may be carried in a first MAC subPDU corresponding to MAC RAR and the enhanced part of the enhanced timing advance may be carried in a second MAC subPDU different from the first MAC subPDU as described in FIG. 18.

Commercial interests for some embodiments are as follows. 1. Solving issues in the prior art. 2. Improving PDC control or management flexibility. 3. Enhancing the timing advance granularity. 4. Carrying out accurate propagation delay compensation. 5. Enhancing the reliability of the network. 6. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

Analysis for Time Synchronization Error

The enhanced timing advance is proposed in the present application to satisfy synchronization requirements for IIoT applications, for example. The synchronization budget for Uu interface (i.e., Uu interface is the interface between the UE and the gNB) is analyzed below, and the benefits of the proposed enhanced timing advance in comparison to legacy timing advance is also provided.

1. Use Cases for Further Study on Propagation Delay Compensation (PDC)

TABLE 8

| | | 5GS | | | |
|---|---|---|---|---|---|
| User-specific | Number of devices in | synchronicity | | | |
| clock | one Communication | budget | | | |
| synchronicity | group for clock | requirement | | Service | |
| accuracy level | synchronisation | (note) | | area | Scenario |
| 2 | Up to 300 UEs | ≤900 | ns | ≤1000 m × 100 m | Control-to-control |
| | | | | | communication for |
| | | | | | industrial controller |
| 4 | Up to 100 UEs | <1 | μs | <20 km² | Smart Grid: |
| | | | | | synchronicity |
| | | | | | between PMUs |

2. Synchronization Error Budget

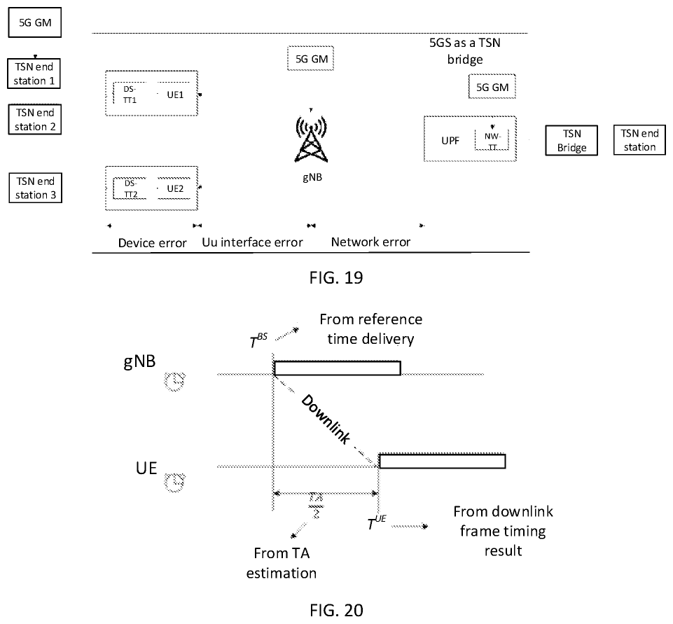

The 5G System (5GS) end-to-end (E2E) synchronization budget could be split into three parts namely Device, Uu interface and Network, as indicated in FIG. 19. The synchronization error of the three parts will be described in the following Table 9 based on the three scenarios.

Scenario 1: In the control-to-control communication use case, where time sensitive network (TSN) end stations behind a target UE are synchronized to any Time Domain (TD), from a GM behind the core network (CN). The 5GS introduced error is caused by the relative time-stamping inaccuracy at the network TSN translator (NW-TT) and the device side TSN translators (DS-TTs).

Scenario 2: In the control-to-control communication use case, where TSN end stations behind a target UE are synchronized to any TD, from a GM behind the UE. The 5GS introduced error is caused by the relative time-stamping inaccuracies at the involved DS-TTs.

Scenario 3: In the smart grid use case, where the TSN end stations behind a target UE are synchronized to the 5G GM TD. The 5GS introduced error is caused by the synchronization of the 5G clock to the DS-TT.

TABLE 9

| | Scenario 1 | Scenario 2 | Scenario 3 |
|---|---|---|---|
| Device error (1) | ±50 ns | ±50 ns | ±50 ns |
| Network error (2) | \| TE \| ~N*40 ns, N = 5 is | \| TE \| ~N*40 ns, N = 5 is | ±100 ns |
| | the maximum number of PTP hops. | maximum number of PTP hops. | |
| | ±200 ns | ±200 ns | |
| Uu interface error (3) | (3) = 900 ns − (1) − (2) − | (3) = 1/2 * [900 ns − | (3) = 1000 ns − (1) − (2) − |
| | 5 ns = 645 ns | 2*(1) − 2*(2) − 2*5] = 195 ns | 5 = 845 ns |
| | (note: 5 ns is error for | | |
| | 10 ns granularity.) | | |

3. Evaluation on the Time Synchronization Accuracy over Uu Interface

As illustrated in FIG. 20, the basic mechanism of time synchronization between a UE and a gNB can be expressed as the equation below. That is, the time clock of the UE is equal to the received time clock of the gNB plus the downlink propagation delay.

T^{UE}=T^{BS}+P_{DL}

T^{UE}=(T^{BS}+ERR_{Bs_timing})+(P_{DL}+ERRP_{P_DL})

T^{UE}=T^{BS}+P_{DL} (ERR_{Bs_timing}+ERR_{P_DL})

T^{UE}=T^{BS}+P_{DL}[ERR_{Bs_timing}+½*(ERR_{asymmetry}+ERR_{Bs_detect}+ERR_{TA_indicate}+Te)]

Therefore, total error of the time synchronization is:

ERRₜₒₜₐₗ=ERR_{Bs_timing}+½*(ERR_{asymmetry}+ERR_{Bs_detect}+ERR_{TA_indicate}+Te)

In the following, individual error for the gNB, the UE, and the propagation delay was discussed. BS timing error (ERR_{BS_timing})
=frame timing accuracy of BS+indicating error associated to the indication granularity of TBs
=Time Alignment Error (TAE)+5 ns (minimum of granularity=10 ns)

TABLE 10

| BS timing error | Single | Indoor | Smart grid | Ericsson |
|---|---|---|---|---|
| (ERR_{BS}_{_{—}}_{timing}) | carrier | scenario | scenario | comments |
| | 70 ns | ±135 ns | ±205 ns | 87.5 ns (50 ns for |
| | | | | baseband |
| | | | | internal error + |
| | | | | 65/2 for error |
| | | | | from baseband |
| | | | | to one antenna |
| | | | | connector) |

From recent 3GPP technical specification release, there is various requirement for the TAE under different cases.

TABLE 11
6.5.3.2 Minimum requirement for BS type 1-C and BS type 1-H

For MIMO transmission, at each carrier frequency, TAE shall not exceed 65 ns.
For intra-band contiguous carrier aggregation, with or without MIMO, TAE shall not exceed 260 ns.
For intra-band non-contiguous carrier aggregation, with or without MIMO, TAE shall not exceed 3 μs.
For inter-band carrier aggregation, with or without MIMO, TAE shall not exceed 3 μs.
The time alignment error requirements for NB-IoT are specified in TS 36.104 [13] clause 6.5.3.

UE Timing Error (Te)
=detecting error of DL signal+implementation error of the UE due to the internal processing jitter.
=initial transmit timing error (Te)

TABLE 12

| UE timing error (Te) | SCS = 15 KHz | SCS = 30 KHz |
|---|---|---|
| | 390 ns (12*64*Tc) | 260 ns (8*64*Tc) |

From recent 3GPP technical specification release, Te has various values under different scenarios.

TABLE 13

| Frequency | SCS of SSB | SCS of uplink | |
|---|---|---|---|
| Range [symbol] | signals (kHz) [symbol] | signals (kHz) [symbol] | T_{c} [symbol] |
| 1 [symbol] | 15 [symbol] | 15 [symbol] | 12*64*T_{c} [symbol] |
| | | 30 [symbol] | 10*64*T_{c} [symbol] |
| | | 60 [symbol] | 10*64*T_{c} [symbol] |
| | 30 [symbol] | 15 [symbol] | 8*64*T_{c} [symbol] |
| | | 30 [symbol] | 8*64*T_{c} [symbol] |
| | | 60 [symbol] | 7*64*T_{c} [symbol] |
| 2 [symbol] | 120 [symbol] | 60 [symbol] | 3.5*64*T_{c} [symbol] |
| | | 120 [symbol] | 3.5*64*T_{c} [symbol] |
| | 240 [symbol] | 60 [symbol] | 3*64*T_{c} [symbol] |
| | | 120 [symbol] | 3*64*T_{c} [symbol] |

Note 1:
T_{c} is the basic timing unit defined in TS 38.211 [6]

[symbol]

From recent 3GPP technical specification release, there is a UE Timing Advance adjustment accuracy requirement. (Note: Timing Advance adjustment accuracy should be included in UE timing error, Te.)

TABLE 14

| UL Sub Carrier | | | | |
|---|---|---|---|---|
| Spacing(kHz) [symbol] | 15 [symbol] | 30 [symbol] | 60 [symbol] | 120 [symbol] |
| UE Timing Advance | ±256 T_{c} [symbol] | ±256 T_{c} [symbol] | ±128 T_{c} [symbol] | ±32 T_{c} [symbol] |
| adjustment accuracy [symbol] | | | | |

DL propagation delay estimation error (TA estimation error, ERR_{P_DL})
=1/2* [DL-UL asymmetry (ERR_{asymmetry})+BS detecting error (ERR_{BS_detect}) +T_{A} Indicating error (ERR_{TA_indicate})
+Te (i.e., include T_{A} adjustment accuracy)]

(1) Asymmetry is only present if the second path is stronger and of a very longer propagation delay. Therefore, for indoor scenario, DL-UL asymmetry could assume zero. For smart grid scenario, DL-UL asymmetry could be set to ±160 ns.

(2) Based on simulations, BS detecting error assumes to be 100 ns.

(3) The indicating granularity of T_{A} command causes error that can be as large as half of the indicating granularity. According to 38.213, the T_{A} indicating granularity is 16·64·T_{c}/2^{μ}, so the indicating error can be assumed as +/−8·64·T_{c}/2^{μ}.

(4) Based on Table 13, Te could be 390 ns for SCS=15 KHz SCS and 260 ns for SCS=30 KHz.

TABLE 15

| ERR_{P}_{_{—}}_{DL} | SCS = 15 KHz | SCS = 30 KHz |
|---|---|---|
| Indoor | 375 ns | 245 ns |
| Smart grid (outdoor) | 455 ns | 325 ns |

Based on above equations and above calculations, the following result is obtained.

TABLE 16

| | SCS = 15 KHz | | SCS = 15 KHz | | SCS = 30 KHz | | SCS = 30 KHz | |
|---|---|---|---|---|---|---|---|---|
| Error source | (worst case) | | (enhanced) | | (worst case) | | (enhanced) | |
| Time Alignment Error (TAE) (1) | 65 | ns | 65 | ns | 65 | ns | 65 | ns |
| indicating error associated to | 5 | ns | 5 | ns | 5 | ns | 5 | ns |
| the indication granularity (2) | | | | | | | | |
| UE timing error (Te) (3) | 390 | ns | 390 | ns | 260 | ns | 260 | ns |
| DL-UL asymmetry for indoor | 0 | | 0 | | 0 | | 0 | |
| (ERR_{asymmetry}_{_{—}}_{indoor}) (4) | | | | | | | | |
| DL-UL asymmetry for smart | 160 | ns | 160 | ns | 160 | ns | 160 | ns |
| grid (ERR_{asymmetry}_{_{—}}_{smartgrid}) (5) | | | | | | | | |
| BS detecting error | 100 | ns | 100 | ns | 100 | ns | 100 | ns |
| (ERR_{BS}_{_{—}}_{detect}) (6) | | | | | | | | |
| T_{A} Indicating error | 260 | ns | 65 | ns | 130 | ns | 32.5 | ns |
| (ERR_{TA}_{_{—}}_{indicate}) (7) | | | | | | | | |
| Total error for indoor = | 445 | ns | 347.5 | ns | 315 | ns | 266.25 | ns |
| (1) + (2) + 1/2*[(3) + (4) + (6) + (7)] | | | | | | | | |
| Total error for smart grid = | 525 | ns | 427.5 | ns | 395 | ns | 346.25 | ns |
| (1) + (2) + 1/2*[(3) + (5) + (6) + (7)] | | | | | | | | |

Taking SCS=30 KHz for example, it showed that with timing advanced enhancements achieved by the present application, the total error for indoor (i.e., 266.25 ns) is improved as compared to legacy timing advance use case (i.e., 315 ns), and the improvement is on TA Indicating error. Although it still cannot meet the Uu synchronization budget (i.e., 195 ns), it is possible that other requirements may be adjusted to meet the requirement of control-to-control use case in scenario 2.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-57. (canceled)

58. A method of propagation delay compensation (PDC), performed by a user equipment (UE), the method comprising:
(a) being indicated by a PDC indication;
(b) determining whether to perform PDC based on the PDC indication;
(c) being indicated by timing advance; and
(d) perfroming the PDC based on the timing advance in response to determining to perform the PDC in step (b).

59. The method of claim 58, wherein the step (c) comprises:
receiving a random access response (RAR) comprising the timing advance, which is estimated by using a preamble transmitted by the UE in RRC inactive/idle state,
wherein step (a) comprises:
receiving the random access response (RAR) comprising the PDC indication when the UE is in RRC inactive/idle state.

60. The method of claim 58, wherein at least the step (a) is performed for the UE in Radio Resource Control (RRC) connected state, and the PDC is initiated by a base station (BS), wherein the PDC indication is contained in reference time information used for the UE to update time in RRC connected state, and the reference time information is carried by a downlink (DL) information transfer message.

61. The method of claim 58, wherein at least one of the PDC indication and the timing advance is carried by a Medium Access Control (MAC) Control Element (CE) transmitted when the UE is in RRC connected state.

62. The method of claim 58, wherein at least the step (a) is performed for the UE in Radio Resource Control (RRC) connected state, and the PDC is initiated by the UE, and the method further comprises:
requesting, by the UE, to update the timing advance; and
receiving the PDC indication and the timing advance from a response to the requesting.

63. The method of claim 58, wherein the timing advance is an enhanced timing advance having a non-enhanced part and an enhanced part that are used together to control the amount of timing adjustment, and the enhanced part has one or more bits used to control part of the amount of timing adjustment.

64. The method of claim 63, wherein the enhanced part of the enhanced timing advance is a decimal part with a value decided by a fraction with a non-zero denominator represented by one or more binary digits.

65. The method of claim 64, wherein the decimal part of the enhanced timing advance is determined by two binary digits and has a corresponding decimal value which is 0/4, ¼, 2/4 or ¾, or the decimal part of the enhanced timing advance is determined by three binary digits and has a corresponding decimal value which is 0/8, ⅛, 2/8, ⅜, 4/8, ⅝, 6/8 or ⅞.

66. The method of claim 63, wherein the non-enhanced part and the enhanced part of the enhanced timing advance are carried in a same MAC sub Protocol Data Unit (subPDU), wherein one MAC PDU subheader is used to indicate both the non-enhanced part and the enhanced part of the enhanced timing advance.

67. The method of claim 63, wherein the non-enhanced part and the enhanced part of the enhanced timing advance are carried in two different MAC sub Protocol Data Units (subPDUs), wherein one MAC PDU subheader is used to indicate the non-enhanced part and another one MAC PDU subheader is used to indicate the enhanced part of the enhanced timing advance.

68. The method of claim 63, wherein the non-enhanced part of the enhanced timing advance is carried in a first MAC subPDU corresponding to MAC RAR and the enhanced part of the enhanced timing advance is carried in a second MAC subPDU different from the first MAC subPDU.

69. A method of propagation delay compensation (PDC), performed by a base station (BS), the method comprising:
(a) indicating to a user equipment (UE) by a PDC indication;
(b) expecting the UE to determine whether to perform PDC based on the PDC indication;
(c) indicating to the UE by timing advance; and
(d) expecting the UE to perfrom the PDC based on the timing advance in response to the UE determining to perform the PDC in step (b).

70. The method of claim 69, wherein the step (c) comprises:
transmitting a random access response (RAR) comprising the timing advance, which is estimated by using a preamble received by the BS from the UE in RRC inactive/idle state,
wherein step (a) comprises:
transmitting the random access response (RAR) comprising the PDC indication when the UE is in RRC inactive/idle state.

71. The method of claim 69, wherein at least the step (a) is performed when the UE in Radio Resource Control (RRC) connected state, and the PDC is initiated by the BS, wherein the PDC indication is contained in reference time information used for the UE to update time in RRC connected state, and the reference time information is carried by a downlink (DL) information transfer message.

72. The method of claim 69, wherein at least one of the PDC indication and the timing advance is carried by a Medium Access Control (MAC) Control Element (CE) transmitted by the BS when the UE is in RRC connected state.

73. The method of claim 69, wherein at least the step (a) is performed when the UE in Radio Resource Control (RRC) connected state, and the PDC is initiated by the UE, and the method further comprises:
receiving a request from the UE to update the timing advance; and
transmitting the PDC indication and the timing advance to the UE by a response to the received request.

74. The method of claim 69, wherein the timing advance is an enhanced timing advance having a non-enhanced part and an enhanced part that are used together to control the amount of timing adjustment, and the enhanced part has one or more bits used to control part of the amount of timing adjustment.

75. The method of claim 74, wherein the enhanced part of the enhanced timing advance is a decimal part with a value decided by a fraction with a non-zero denominator represented by one or more binary digits.

76. A user equipment (UE), communicating with a base station (BS) in a network, the UE comprising a processor, configured to call and run program instructions stored in a memory, to execute the method of claim 58.

77. A base station (BS), communicating with a user equipement (UE) in a network, the BS comprising a processor, configured to call and run program instructions stored in a memory, to execute the method of of claim 69.
